(19) United States
(12) Patent Application Publication
(10) Pub. No.: US 2009/0172696 A1
(43) Pub. Date: Jul. 2, 2009

(54) SERVICE-BASED CONTENT MANAGEMENT

(76) Inventors: Dikran S. Meliksetian, Danbury, CT (US); Nianjun Zhou, Danbury, CT (US)

Correspondence Address: HOFFMAN WARNICK LLC, 75 STATE ST, 14TH FLOOR, ALBANY, NY, 12207, US

(21) Appl. No.: 11/966,200

(22) Filed: Dec. 28, 2007

(51) Int. Cl. G06F 9/54

(52) U.S. Cl. 719/315

(57) ABSTRACT

The present invention leverages and modifies service-oriented architecture and concepts to provide an enterprise content management (ECM) system as a service. This allows organizations (potential customers) to be provided with a service as opposed to purchasing a software product. In the present invention, it is disclosed how to build a reusable enterprise content management ECM as an asset being a brick for business service using SOA methodology. To achieve these goals, this invention has, among other things/components: (1) abstracts the generic portion of individual ECM; (2) introduces a new unique component to allow configuring the data modeling part and workflow of each individual ECM; (3) provides a common UI for the content edit and view; and (4) provides a plug-in component for bulk content processing.

### FIELD OF THE INVENTION

The present invention generally relates to (enterprise) content management. Specifically, the present invention relates to an approach for providing enterprise content management (ECM) as a service.

### BACKGROUND OF THE INVENTION

In recent years, Service-Oriented Architecture (SOA) and related concepts has been an increasingly more widely used approach. SOA is an architectural style that guides all aspects of creating and using business processes, packaged as services, throughout their lifecycle, as well as defining and provisioning the IT infrastructure that allows different applications to exchange data and participate in business processes loosely coupled from the operating systems and programming languages underlying those applications. SOA represents a model in which functionality is decomposed into small, distinct units (services), which can be distributed over a network and can be combined together and reused to create business applications. These services communicate with each other by passing data from one service to another, or by coordinating an activity between two or more services. The concepts of Service Oriented Architecture are often seen as built upon, and the evolution of, the older concepts of distributed computing and modular programming.

Companies have long sought to integrate existing systems in order to implement information technology (IT) support for business processes that cover all present and prospective systems requirements needed to run the business end-to-end. A variety of designs can be used to this end, ranging from rigid point-to-point electronic data interchange (EDI) interactions to Web auctions. By updating older technologies, such as Internet-enabling EDI-based systems, companies can make their IT systems available to internal or external customers; but the resulting systems have not proven to be flexible enough to meet business demands.

A flexible, standardized architecture is required to better support the connection of various applications and the sharing of data. SOA is one such architecture. It unifies business processes by structuring large applications as an ad-hoc collection of smaller modules called services. These applications can be used by different groups of people both inside and outside the company, and new applications built from a mix of services from the global pool exhibit greater flexibility and uniformity. One should not, for example, have to provide redundantly the same personal information to open an online checking, savings or IRA account, and further, the interfaces one interacts with should have the same look and feel and use the same level and type of input data validation. Building all applications from the same pool of services makes achieving this goal much easier and more deployable to affiliate companies. An example of this might be interacting with a rental car company's reservation system even though you are doing so from an airline's reservation system.

SOAs build applications out of software services. Services are relatively large, intrinsically unassociated units of functionality, which have no calls to each other embedded in them. They typically implement functionalities most humans would recognize as a service, such as filling out an online application for an account, viewing an online bank statement, or placing an online booking or airline ticket order. Instead of services embedding calls to each other in their source code, protocols are defined which describe how one or more services can talk to each other. This architecture then relies on a business process expert to link and sequence services, in a process known as orchestration, to meet a new or existing business system requirement.

### SUMMARY OF THE INVENTION

The present invention leverages and modifies service-oriented architecture and concepts to provide an enterprise content management (ECM) system as a service. This allows organizations (potential customers) to be provided with a service as opposed to purchasing a software product. In the present invention, it is disclosed how to build a reusable enterprise content management ECM as an asset being a brick for business service using SOA methodology. To achieve these goals, this invention has, among other things/components: (1) abstracts the generic portion of individual ECM; (2) introduces a new unique component to allow configuring the data modeling part and workflow of each individual ECM; (3) provides a common UI for the content edit and view; and (4) provides a plug-in component for bulk content processing.

A first aspect of the present invention provides a service-based content management system, comprising: a content management system for storing content and workflow definitions; a web toolkit being configured to implement content management models and corresponding actions in a model view controller (MVC) framework; a user interface (UI) being implemented by content management portlets; a bulk processing component to support bulk processing of data content; a configuration service implemented by offering pre-deployment configuration and post-deployment configuration; a set of configuration portlets implemented as a self-service portal in order to allow customer administrator to configure content management portlets; a reporting service implemented as a set of standalone services for reporting events; an event generator for storing the events and having agents poll events from the tables; and an on boarding tool to support data modeling import and export between physical systems.

A second aspect of the present invention provides a method for deploying a content management system as a service, comprising: deploying the following components in at least one computer infrastructure: a content management system for storing content and workflow definitions; a web toolkit comprising of suite of Java classes to implement content management models and corresponding actions in a model view controller (MVC) framework; a user interface (UI) being implemented by content management portlets using Java Server faces; a bulk processing component to support bulk processing of data content; a configuration service implemented by offering pre-deployment configuration and post-deployment configuration; a set of configuration portlets implemented as a self-service portal in order to allow customer administrator to configure content management portlets; a reporting service implemented as a set of standalone services for reporting events; an event generator for storing the events and having agents poll events from the tables; and an on boarding tool to support data modeling import and export between physical systems.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a block diagram of the components of the present invention.

FIG. 2 depicts a block diagram of an event generation service according to the present invention.

FIG. 3 a more specific computerized implementation according to the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

For convenience, the Detailed Description of the Invention has the following Sections:

I. General Description

II. Computerized Implementation

### I. General Description

As indicated above, the present invention leverages and modifies service-oriented architecture and concepts to provide an enterprise content management (ECM) system as a service. This allows organizations (potential customers) to be provided with a service as opposed to purchasing a software product. In the present invention, it is disclosed how to build a reusable enterprise content management ECM as an asset being a brick for business service using SOA methodology. To achieve these goals, this invention has, among other things/components: (1) abstracts the generic portion of individual ECM; (2) introduces a new unique component to allow configuring the data modeling part and workflow of each individual ECM; (3) provides a common UI for the content edit and view; and (4) provides a plug-in component for bulk content processing.

Some advantages of creating a reusable asset are (1) to reduce the development cost to maximize the code reuse; (2) to realize the idea of software-as-service to minimize the code development for a business solution, and (3) to expedite the business solution deployment.

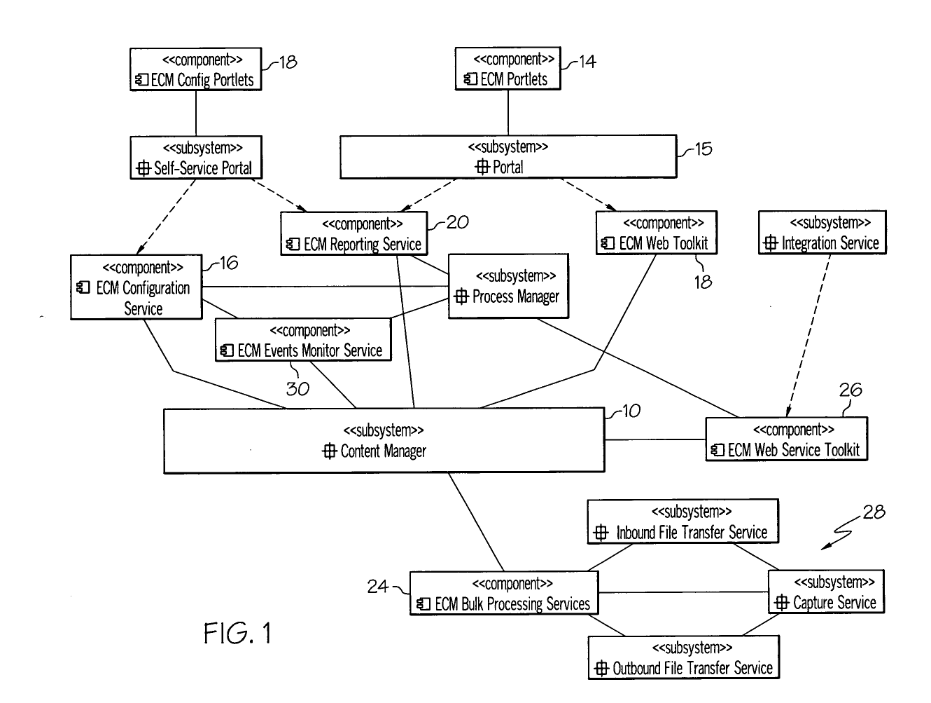

Referring now to FIG. 1, a block diagram depicting the components of the service-based content management system of the present invention are shown. These components are typically, services, portlets, portals, interfaces, toolkits, etc. that allows for a content management such (e.g., ECM) to be delivered as a service for customers. The will be described in list format as shown below:

Content Management System 10 such as the Content management system product available from IBM Corp. is used as the content storage and workflow definitions

ECM Web Toolkit 12 comprises of suite of Java classes to implement the content management models and corresponding actions in the MVC framework. It builds upon the available content management system 10's APIs such as IBM's Content management system Object-Oriented interfaces. ECM Web toolkit 12 is independent of any framework and equally usable with Java Server Faces as well as Struts frameworks within a Portal environment 15 or within a simple Web Application environment. It is typically middleware component to separate the details of the implementation of the physical content storage from the abstract concepts of content manipulation

User interface (UI) 14 is implemented by ECM portlets using Java Server faces—A set of generic and configurable portlets that support the use case described in the user interaction use cases section. The ECM portlets are designed and developed to be configurable and integrate-able on solutions built with the ECM services. The portlets are categorized in three main groups: content manipulation portlets, task processing portlets and reporting portlet. Each group is packaged separately and deployed separately. User interface 14 builds upon the pluggable web toolkit 12 to allow having content creation, updating, deletion and search. The UI is rendered dynamically based on the data modeling. Therefore, it can support any specific business application;

Configuration Service 16 is typically implemented in two separated steps: (1) offering configuration—The configuration is performed at offering creation time, the native content management system administration tool, such as the IBM CM System Administration Client is used for this task; and (2) post-deployment Configuration—This portion of configuration is integrated together with the Self Care Portal (SCP) to dynamically configure certain Meta information of an ECM application for a particular tenant. The second configuration is implemented as a Java middleware. Configuration service 15 supports the creation and modifying the data model and workflow for an ECM application.

Configuration portlets 18 are set of portlets are deployed as self-service portal in order to allow the customer administrator to configure the ECM portlets. The configuration service 16 and portlets make the ECM of the present invention becoming a reusable solution. The configuration includes: Data Type View Configuration; Workflow View Configuration; Search Configuration; Content ACL Configuration; Searchable Attribute Configuration; and Reporting Configuration

The ECM reporting service provides the tools to implement the reporting use cases. The output of the reporting service is available to administrators through a self-service portal and to other end users through the portal. The use cases for reporting include the request for and viewing of reports such as:

Regular reporting: This use case represents the functionality to allow a user to create his/her operational reporting based on pre-existing reporting templates with pre-defined criteria for item generation, modification or task completion.

Ad-hoc reporting: This is the function to allow a user to create his/her customize report. The user is allowed to enter both the search criteria and also how the report will be rendered (order, and attributes). A set of attributes is presented to the use to allow him/her to submit a search; also the user should able to specify the output layout and the file format (word, pdf, and so on).

Event generator is implemented using the database tables to store the events and having an agent to poll the event from the tables. The events are generated using database triggers. The event generator is also implemented as an EJB application. Event generator 22 is typically realized as a Configurable Event Generation Module that provides a mechanism for an ECM application to communicate with other business applications residing at different physical systems. The source of these events is the content modification and workflow changes. The events are generated by putting the events into an event repository and an event generator will periodically poll the event repository to publish these events into message queues. The events generated by the event generator are available for consumption by other business applications to provide integration.

Bulk processing service 24 is to support the bulk processing of the data content from creation, modification, deletion, and retrieval. This component provide a plug-in framework to allow each business application having their own data processing methods but sharing the common services such as—process scheduler, inbound and outbound FTP servers, and security control.

Web Service 26 to allow external applications integrating with the ECM system. The service includes a set of web service interfaces for basic content manipulation and workflow management.

On Boarding Tool 28 supports the data modeling import and export from one physical system to another system.

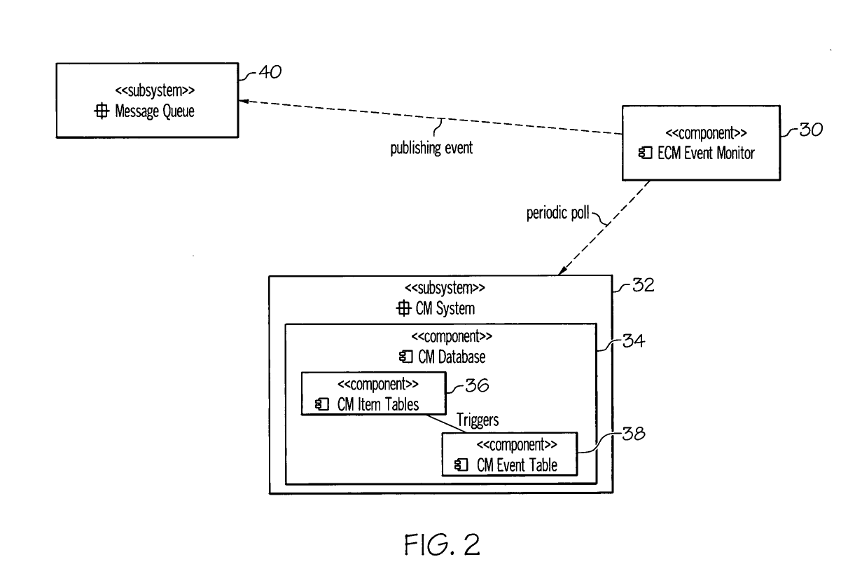

Referring to FIG. 2, an event generation service in the context of content management system 32 is shown. As depicted, event generation service 32 encompasses content management database 34, with event tables 36 and 38. When an event is triggered by the event generator, it is detected by event monitor 30, which stores an event descriptive message in message queue 40.

### II. Computerized Implementation

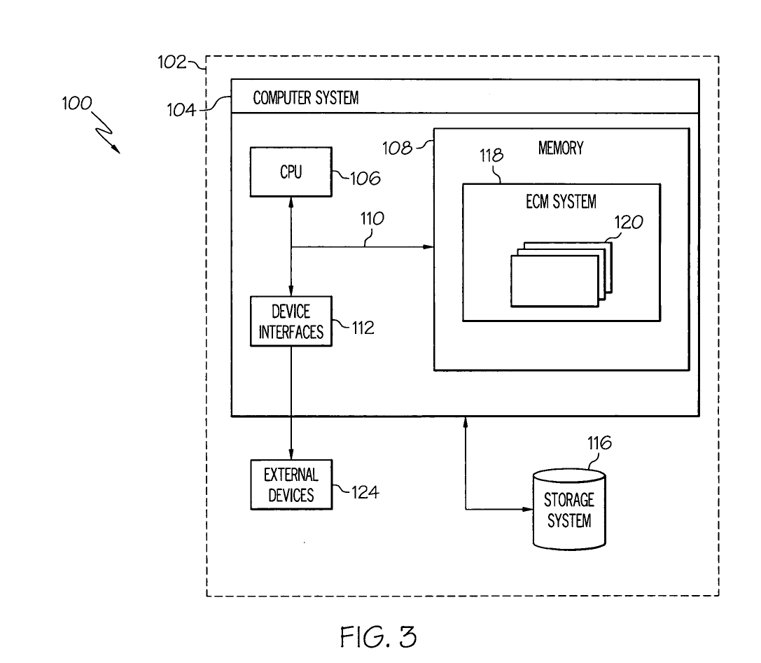

Referring now to FIG. 3, a more detailed diagram of a computerized implementation 100 of the present invention is shown. As depicted, implementation 100 includes computer system 104 deployed within a computer infrastructure 102. This is intended to demonstrate, among other things, that the present invention could be implemented within a network environment (e.g., the Internet, a wide area network (WAN), a local area network (LAN), a virtual private network (VPN), etc.), or on a stand-alone computer system. In the case of the former, communication throughout the network can occur via any combination of various types of communications links. For example, the communication links can comprise addressable connections that may utilize any combination of wired and/or wireless transmission methods. Where communications occur via the Internet, connectivity could be provided by conventional TCP/IP sockets-based protocol, and an Internet service provider could be used to establish connectivity to the Internet. Still yet, computer infrastructure 102 is intended to demonstrate that some or all of the components of implementation 100 could be deployed, managed, serviced, etc. by a service provider who offers to implement, deploy, and/or perform the functions of the present invention for others, as indicated above

As shown, computer system 104 includes a processing unit 106, a memory 108, a bus 110, and input/output (I/O) interfaces 112. Further, computer system 104 is shown in communication with external I/O devices/resources 114 and storage system 116. In general, processing unit 106 executes computer program code, ECM system 118, which is stored in memory 108 and/or storage system 116. While executing computer program code, processing unit 106 can read and/or write data to/from memory 108, storage system 116, and/or I/O interfaces 112. Bus 110 provides a communication link between each of the components in computer system 104. External devices 114 can comprise any devices (e.g., keyboard, pointing device, display, etc.) that enable a user to interact with computer system 104 and/or any devices (e.g., network card, modem, etc.) that enable computer system 104 to communicate with one or more other computing devices.

Computer infrastructure 102 is only illustrative of various types of computer infrastructures for implementing the invention. For example, in one embodiment, computer infrastructure 102 comprises two or more computing devices (e.g., a server cluster) that communicate over a network to perform the process(es) of the invention. Moreover, computer system 104 is only representative of various possible computer systems that can include numerous combinations of hardware. To this extent, in other embodiments, computer system 104 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively. Moreover, processing unit 106 may comprise a single processing unit, or be distributed across one or more processing units in one or more locations, e.g., on a client and server. Similarly, memory 108 and/or storage system 116 can comprise any combination of various types of data storage and/or transmission media that reside at one or more physical locations. Further, I/O interfaces 112 can comprise any system for exchanging information with one or more external device 114. Still further, it is understood that one or more additional components (e.g., system software, math co-processing unit, etc.) not shown in FIG. 3 can be included in computer system 104. However, if computer system 104 comprises a handheld device or the like, it is understood that one or more external devices 114 (e.g., a display) and/or storage system 116 could be contained within computer system 104, not externally as shown.

Storage system 116 can be any type of system (e.g., a database) capable of providing storage for information under the present invention. To this extent, storage system 116 could include one or more storage devices, such as a magnetic disk drive or an optical disk drive. In another embodiment, storage system 116 includes data distributed across, for example, a local area network (LAN), wide area network (WAN) or a storage area network (SAN) (not shown). In addition, although not shown, additional components, such as cache memory, communication systems, system software, etc., may be incorporated into computer system 104. It should be understood computer system 104 could be any combination of human, hardware and/or software. It is shown as such to illustrate the functions as described herein.

Shown in memory 108 of computer system 104 is ECM system 118 having services/components/modules 120. These items represent the services/components discussed above and represent the teachings of the present invention.

While shown and described herein as a service-based content management system, it is understood that the invention further provides various alternative embodiments. For example, in one embodiment, the invention provides a computer-readable/useable medium that includes computer program code to enable a computer infrastructure for providing a service-based content management system. To this extent, the computer-readable/useable medium includes program code that implements the process(es) of the invention. It is understood that the terms computer-readable medium or computer useable medium comprises one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as memory 108 (FIG. 3) and/or storage system 116 (FIG. 3) (e.g., a fixed disk, a read-only memory, a random access memory, a cache memory, etc.), and/or as a data signal (e.g., a propagated signal) traveling over a network (e.g., during a wired/wireless electronic distribution of the program code).

In another embodiment, the invention provides a business method that performs the process of the invention on a subscription, advertising, and/or fee basis. That is, a service provider, such as a Solution Integrator, could offer to method for providing a service-based content management system. In this case, the service provider can create, maintain, support, etc., a computer infrastructure, such as computer infrastructure 102 (FIG. 3) that performs the process of the invention for one or more customers. In return, the service provider can receive payment from the customer(s) under a subscription and/or fee agreement and/or the service provider can receive payment from the sale of advertising content to one or more third parties.

In still another embodiment, the invention provides a computer-implemented method for providing a service-based content management system. In this case, a computer infrastructure, such as computer infrastructure 102 (FIG. 3), can be provided and one or more systems for performing the process of the invention can be obtained (e.g., created, purchased, used, modified, etc.) and deployed to computer infrastructure 102. To this extent, the deployment of a system can comprise one or more of: (1) installing program code on a computing device, such as computer system 104 (FIG. 3), from a computer-readable medium; (2) adding one or more computing devices to the computer infrastructure; and (3) incorporating and/or modifying one or more existing systems of the computer infrastructure to enable the computer infrastructure to perform the process of the invention.

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and/or (b) reproduction in a different material form. To this extent, program code can be embodied as one or more of: an application/software program, component software/a library of functions, an operating system, a basic I/O system/driver for a particular computing and/or I/O device, and the like.

A data processing system suitable for storing and/or executing program code can be provided hereunder and can include at least one processor communicatively coupled, directly or indirectly, to memory element(s) through a system bus. The memory elements can include, but are not limited to, local memory employed during actual execution of the program code, bulk storage, and cache memories that provide temporary storage of at least some program code in order to reduce the number of times code must be retrieved from bulk storage during execution. Input/output or I/O devices (including, but not limited to, keyboards, displays, pointing devices, etc.) can be coupled to the system either directly or through intervening I/O controllers.

Network adapters also may be coupled to the system to enable the data processing system to become coupled to other data processing systems, remote printers, storage devices, and/or the like, through any combination of intervening private or public networks. Illustrative network adapters include, but are not limited to, modems, cable modems and Ethernet cards.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims. For example, it should be understood that Java-specific technology has been referenced herein only as one possible way to implement the teachings recited herein. Along these lines, the teachings of the present invention could be implemented using any programming language now known or later developed.

We claim:

1. A service-based content management system, comprising:
a content management system for storing content and workflow definitions;
a web toolkit being configured to implement content management models and corresponding actions in a model view controller (MVC) framework;
a user interface (UI) being implemented by content management portlets;
a bulk processing component to support bulk processing of data content
a configuration service implemented by offering pre-deployment configuration and post-deployment configuration;
a set of configuration portlets implemented as a self-service portal in order to allow customer administrator to configure content management portlets;
a reporting service implemented as a set of standalone services for reporting events;
an event generator for storing the events and having agents poll events from the tables; and
an on boarding tool to support data modeling import and export between physical systems.

2. The system of claim 1, the web toolkit being independent of any framework and usable with Java Server Faces as well as a Struts frameworks within a Portal environment or within a simple Web Application environment.

3. The system of claim 1, the event generator providing a mechanism for content management applications to communicate with other business applications residing at different physical systems.

4. The system of claim 1, the configuration service being implemented with a self care portal to dynamically configure meta information of a content management application for a particular party.

5. The system of claim 1, the system being implemented as a program product stored on a computer readable medium.

6. The method of claim 1, the user interface (UI) being implemented by content management portlets using Java Server faces;

7. The method of claim 1, the web toolkit comprising of suite of Java classes.

8. A method for deploying a content management system as a service, comprising:
deploying the following components in at least one computer infrastructure:
a content management system for storing content and workflow definitions;
a web toolkit comprising of suite of Java classes to implement content management models and corresponding actions in a model view controller (MVC) framework;
a user interface (UI) being implemented by content management portlets using Java Server faces;
a bulk processing component to support bulk processing of data content;
a configuration service implemented by offering pre-deployment configuration and post-deployment configuration;
a set of configuration portlets implemented as a self-service portal in order to allow customer administrator to configure content management portlets;
a reporting service implemented as a set of standalone services for reporting events;
an event generator for storing the events and having agents poll events from the tables; and
an on boarding tool to support data modeling import and export between physical systems.

9. The method of claim 6, the web toolkit being independent of any framework and usable with Java Server Faces as well as a Struts frameworks within a Portal environment or within a simple Web Application environment.

10. The method of claim 6, the event generator providing a mechanism for content management applications to communicate with other business applications residing at different physical systems.

11. The method of claim 6, the configuration service being implemented with a self care portal to dynamically configure meta information of a content management application for a particular party.
